(19) United States
(12) Patent Application Publication
(10) Pub. No.: US 2024/0296317 A1
(43) Pub. Date: Sep. 5, 2024

(54) BI-DIRECTIONAL GRADIENT COMPRESSION FOR DISTRIBUTED AND FEDERATED LEARNING

(71) Applicant: VMware LLC, Palo Alto, CA (US)

(72) Inventors: Yaniv Ben-Itzhak, Herzliya (IL); Shay Vargaftik, Herzliya (IL)

(21) Appl. No.: 18/176,867

(22) Filed: Mar. 1, 2023

(51) Int. Cl. G06N 3/0495; G06N 3/098

(52) U.S. Cl. CPC G06N 3/0495; G06N 3/098

(57) ABSTRACT

Improved techniques for compressing gradient information that is communicated between clients and a parameter server in a distributed or federated learning training procedure are disclosed. In certain embodiments these techniques enable bi-directional gradient compression, which refers to the compression of both (1) the gradients sent by the participating clients in a given round to the parameter server and (2) the global gradient returned by the parameter server to those clients. In further embodiments, the techniques of the present disclosure eliminate the need for the parameter server to decompress each received gradient as part of computing the global gradient, thereby improving training performance.

### BACKGROUND

Unless specifically indicated herein, the approaches described in this section should not be construed as prior art to the claims of the present application and are not admitted as being prior art by inclusion in this section.

Distributed learning (DL) and federated learning (FL) are machine learning techniques that allow multiple networked computing devices/systems, referred to as clients, to collaboratively train an artificial neural network (ANN) with the help of a central server, referred to as a parameter server. The main distinction between these two techniques is that the training dataset used by each FL client is private to that client and thus inaccessible by other FL clients. In DL, the clients are typically owned/operated by a single entity (e.g., an enterprise) and thus may have access to some or all of the same training data.

DL/FL training proceeds over a series of rounds, where each round includes a computation stage and a communication stage. During the computation stage, each client participating in the round performs a training pass on a local copy of the ANN using the client's training dataset, resulting in a vector of derivatives of a loss function with respect to the ANN's model weights (known as a gradient). During the communication stage, the participating clients send their gradients to the parameter server, which aggregates the received gradients (typically via an averaging operation) to obtain a global gradient. In scenarios such as cross-silo FL, the parameter server then sends the global gradient back to the participating clients and each client updates the model weights of its local ANN copy in accordance with the global gradient.

The sizes of the gradients sent from the clients to the parameter server and the global gradient sent from the parameter server to the clients are proportional to the number of parameters in the ANN, which can be very large (e.g., on the order of billions). Thus, DL/FL is often bottlenecked by the amount network bandwidth available for communicating this gradient information. There are existing DL/FL solutions that employ data compression techniques such as stochastic quantization to reduce the number of bits transmitted between the parameter server and the clients. However, for various reasons, these existing solutions focus solely on compressing the gradients sent by the clients to the parameter server and neglect compression of the global gradient sent in the reverse direction from the parameter server to the clients.

In addition, to improve compression performance, several of these existing solutions require each client to pre-process its gradient using a transformation operation that is super-linear in complexity, prior to compressing and sending the gradient to the parameter server. Examples of such transformation operations include random rotation and Kashin's representation. This means that the parameter server must perform an inverse transform that is also super-linear in complexity on each received gradient in order to decompress it, which increases the computational load on the parameter server and slows down training.

### BRIEF DESCRIPTION OF THE DRAWINGS

FIG. 1 depicts an example DL/FL system.

FIG. 2 depicts an example ANN.

FIG. 3 depicts a conventional DL/FL training procedure.

FIG. 4 depicts a modified version of the training procedure of FIG. 3 that includes compression of gradients sent from clients to the parameter server.

FIGS. 5A and 5B depict client and server-side processes for transforming and inversely transforming gradients as part of the training procedure of FIG. 4.

FIG. 6 depicts a DL/FL training procedure that implements bi-directional gradient compression according to certain embodiments.

FIG. 7 depicts a workflow for dynamically adjusting the quantization range used by clients on a per-round basis according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

Embodiments of the present disclosure are directed to improved techniques for compressing gradient information that is communicated between clients and a parameter server in a DL/FL training procedure. In certain embodiments these techniques enable bi-directional gradient compression, which refers to the compression of both (1) the gradients sent by the participating clients in a given round to the parameter server and (2) the global gradient returned by the parameter server to those clients. In further embodiments, the techniques of the present disclosure eliminate the need for the parameter server to decompress each received gradient as part of computing the global gradient, thereby improving training performance.

### 2. Conventional DL/FL

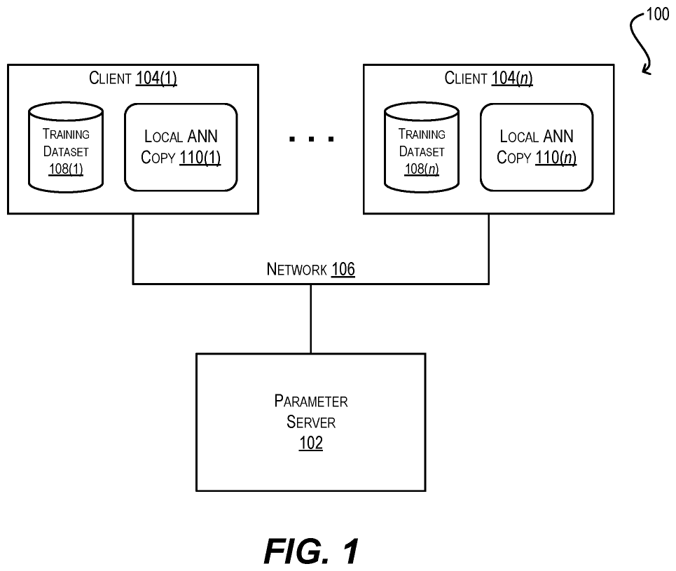

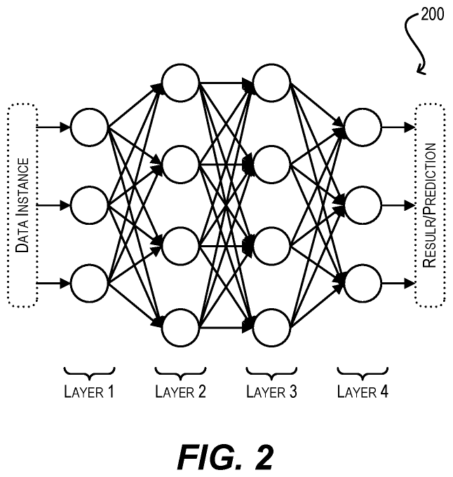

To provide context for the embodiments disclosed herein, FIG. 1 depicts an example DL/FL system 100 comprising a parameter server 102 and a set of clients 104(1)-(n) that are communicatively coupled via a network 106. Each client 104 maintains a training dataset 108 of labeled data instances and a local copy 110 of an ANN M to be trained via system 100. As known in the art, an ANN is a type of machine learning model that includes a collection of nodes which are organized into layers and are interconnected via directed edges. For example, FIG. 2 depicts an example ANN 200 that includes a total of fourteen nodes and four layers 1-4. The edges are associated with parameters (i.e., model weights, not shown) that control how a data instance, which is provided as input to the ANN via the first layer, is processed to generate a result/prediction, which is output by the last layer. These model weights are adjusted during training to optimize the ANN's performance in generating correct results/predictions.

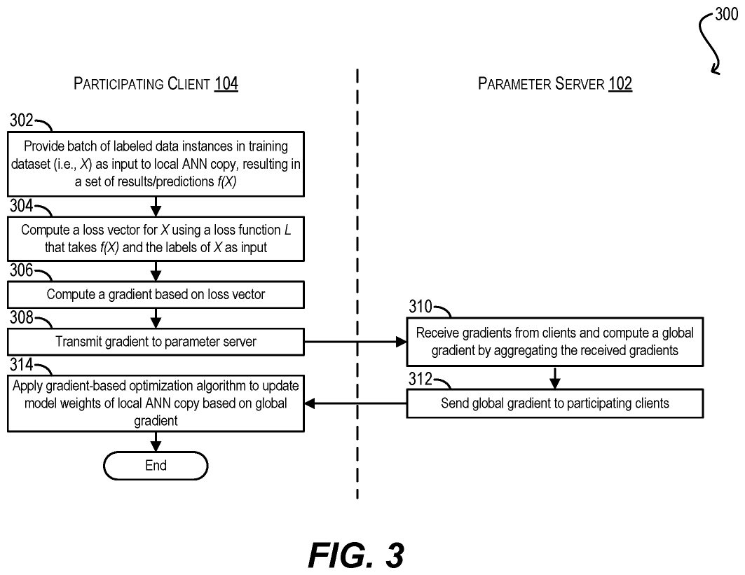

FIG. 3 depicts a workflow 300 that may be performed by parameter server 102 and clients 104(1)-(n) of FIG. 1 for training ANN M using a conventional DL/FL training procedure. This training procedure is carried out over a series of rounds and workflow 300 illustrates the steps performed by these entities as part of a single round r of the procedure.

Starting with steps 302-306, each client 104 participating in round r performs a training pass on its local copy 110 of ANN M that involves (1) providing a batch of labeled data instances in its training dataset 108 (denoted as the matrix X) as input to local ANN copy 110, resulting in a set of results/predictions f (X); (2) computing a loss vector for X using a loss function L that takes f(X) and the labels of X as input; and (3) computing, based on the loss vector, a vector of derivative values of L with respect to the model weights, referred to as a gradient. Generally speaking, this gradient indicates how much the output of local ANN copy 110 changes in response to changes to the ANN's model weights, in accordance with the loss vector. Upon completing the training pass, the client transmits the gradient to parameter server 102 (step 308).

At step 310, parameter server 102 receives the gradients from the participating clients of round r and computes a global gradient by aggregating (e.g., computing the average of) the received gradients. Parameter server 102 then sends the global gradient back to the participating clients (step 312).

Finally, at step 314, each participating client applies a gradient-based optimization algorithm such as stochastic gradient descent to update the model weights of its local ANN copy 110 in accordance with the global gradient and current round r ends. Steps 302-314 are subsequently repeated for additional rounds r+1, r+2, etc. until a termination criterion is reached that ends the DL/FL training procedure. This termination criterion may be, e.g., a lower bound on the size of the global gradient, an accuracy threshold for ANN M, or a number of rounds threshold.

As noted in the Background section, an issue with the conventional DL/FL training procedure shown in FIG. 3 is that the sizes the gradients sent by the participating clients at step 308 and the global gradient sent by parameter server 102 at step 312 are proportional to the number of parameters in ANN M, which may be in the billions. Thus, the time needed to communicate these gradients will often be the main bottleneck for training performance.

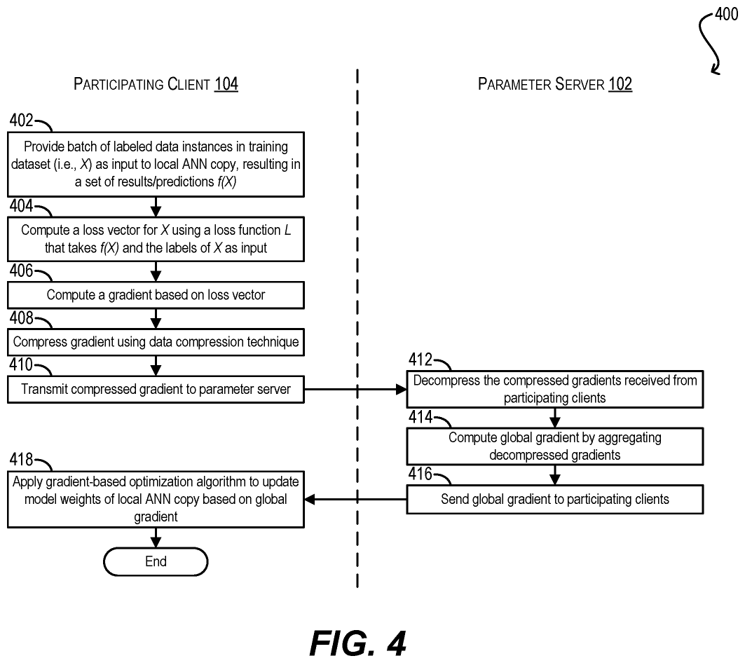

There are a number of existing DL/FL solutions that attempt to solve this problem by leveraging data compression. For example, FIG. 4 depicts a modified version of the training procedure workflow of FIG. 3 (shown via reference numeral 400) that illustrates the general idea behind these existing compression-based solutions. Steps 402-406 of workflow 400 are identical to steps 302-306 of workflow 300. At steps 408 and 410, each participating client 104 of round r compresses its gradient using a data compression technique (such as, e.g., stochastic quantization) and transmits the compressed gradient to parameter server 102, thereby reducing the amount of data communicated to server 102. In response, parameter server 102 decompresses the compressed gradients received from the clients (step 412) and computes the global gradient by aggregating the decompressed gradients (step 414). Finally, parameter server 102 sends back the global gradient to the participating clients (step 416) and each client updates the model weights of its local ANN copy 110 using the global gradient (step 418).

Unfortunately, the approach shown in FIG. 4 suffers from its own set of drawbacks. First, this approach only compresses gradient information transmitted in the “forward” direction (i.e., the gradients sent by the clients to the parameter server) and does not compress gradient information transmitted in the “reverse” direction (i.e., the global gradient sent by the parameter server to the clients). This is because the global gradient is sent only once per round to each client and thus, unlike the multiple gradients transmitted to the parameter server, there is no averaging effect to reduce the approximation error arising out of compressing the global gradient.

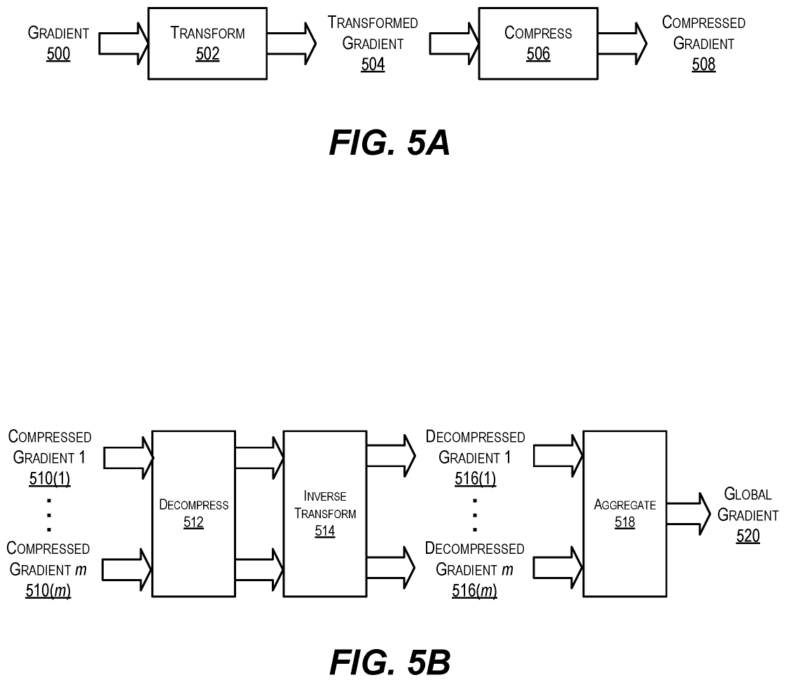

Second, for some existing gradient compression solutions, each client is required to apply a transformation operation (or simply “transform”) to its gradient before compressing and sending it to the parameter server. This is illustrated in FIG. 5A, where a gradient 500 is pre-processed using a transform 502 (e.g., random rotation, Kashin's representation, randomized Hadamard transform, etc.) to generate a transformed gradient 504 and the transformed gradient is subsequently compressed using a data compression technique 506 (e.g., stochastic quantization) to generate a compressed gradient 508 that is sent to parameter server 102.

The client-side use of transform 502 improves compression efficacy by ensuring a uniformly random distribution for the coordinates of the gradient vector, but also requires the parameter server to perform a corresponding inverse transform on every compressed gradient it receives in order to decompress those gradients and to compute the global gradient. This server-side processing, which maps to steps 412 and 414 of FIG. 4, is shown in FIG. 5B via reference numerals 510-520. Accordingly, the overall time needed to obtain the global gradient is increased, which can potentially negate the performance gains achieved via compression. This is particularly problematic for transforms/inverse transforms like random rotation that are super-linear in time complexity (which means that the amount of time needed to execute the transform/inverse transform grows faster than the size of the gradient) because the gradient size will typically be very large to begin with.

### 3. Solution Description

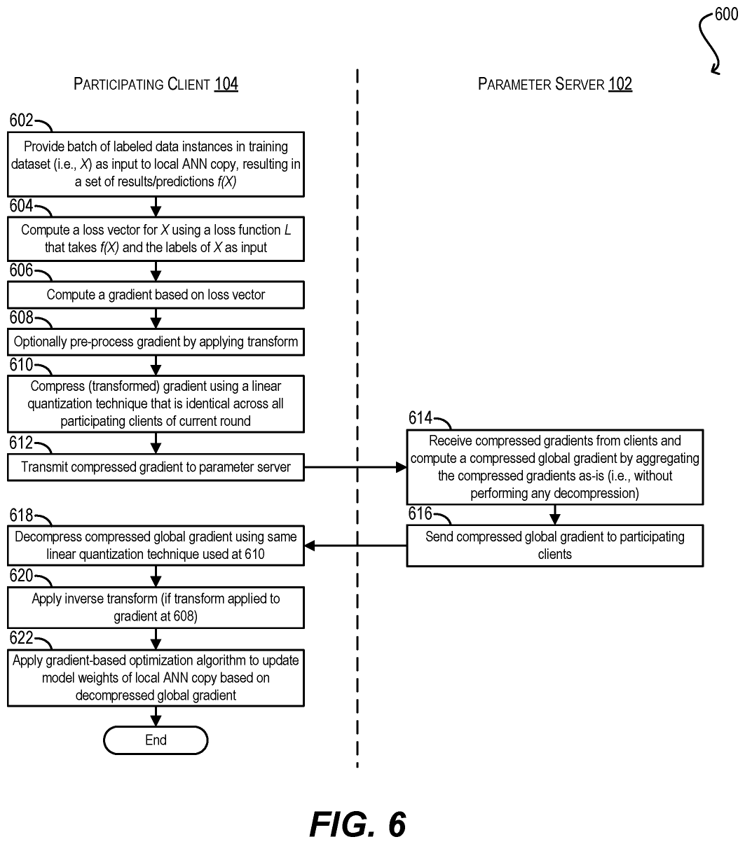

To address the foregoing issues, FIG. 6 depicts a high-level workflow 600 of an improved gradient compression solution for DL/FL training according to certain embodiments. Like workflows 300 and 400 of FIGS. 3 and 4, workflow 600 is performed by clients 104(1)-(n) and parameter server 102 in the context of a single training round r.

At steps 602-606, each client 104 participating in round r can perform a training pass on its local copy 110 of ANN M that involves (1) providing a batch of labeled data instances in its training dataset 108 (denoted as the matrix X) as input to local ANN copy 110, resulting in a set of results/predictions f (X); (2) computing a loss vector for X using a loss function L that takes f(X) and the labels of X as input; and (3) computing a gradient based on the loss vector.

Upon completing the training pass and obtaining the gradient, each participating client can optionally pre-process the gradient by applying a transform such as random rotation, Kashin's representation, or the like (step 608). Each participating client can then compress the (transformed) gradient using a linear quantization technique that is identical across all participating clients of round r (step 610) and transmit the compressed gradient to parameter server 102 (step 612). As known in the art, quantization is a compression technique that involves mapping a set of real values (e.g., the coordinates of a vector) to a smaller set of integer values. Linear quantization is a specific type of quantization that guarantees the following property: the result of linearly quantizing two vectors V1 and V2, adding the quantized vectors together, and de-quantizing the sum is identical to the result of simply adding V1 and V2 together in un-quantized form.

In one set of embodiments, each participating client can carry out step 610 by applying stochastic quantization to the gradient using a particular quantization range (and number of quantization bits) that is common across all participating clients of round r. This quantization range defines a lower and upper bound on the set of integer values that the gradient coordinates may be mapped to, such that (1) any gradient coordinates below the lower bound are thresholded (i.e., clamped) to the lower bound, and (2) any gradient coordinates above the upper bound are thresholded to the upper bound. By enforcing a common stochastic quantization range across all participating clients, the linear quantization property is guaranteed with respect to the compressed gradients generated by those clients. In other embodiments, any other type of linear quantization technique may be employed. For example, rather than thresholding out-of-bounds gradient coordinates that fall below/above the lower/upper bound, such coordinates may be sent as-is (i.e., as their exact, real values) to the parameter server; all other in-bounds gradient coordinates may be quantized according to the quantization range and sent in quantized form.

At step 614, parameter server 102 can receive the compressed gradients from the participating clients of round r and can compute a compressed global gradient by directly aggregating (e.g., computing the average of) the received gradients in their compressed form. Thus, unlike the process shown in FIG. 5B where parameter server 102 is required to inversely transform and decompress each received gradient before aggregating them, in this workflow the parameter server can completely bypass the inverse transform and decompression steps. Parameter server 102 can then send the compressed global gradient back to the participating clients (step 616).

At step 618, each participating client can receive the compressed global gradient and decompress (i.e., de-quantize) it using the same linear quantization technique applied at step 610. This step can involve recovering the real coordinates of the global gradient from the quantized coordinates. The client can also apply an inverse transform to the global gradient after decompression if a transform was originally applied to the outgoing gradient at step 608 (step 620).

Finally, at step 622, each participating client can employ a gradient-based optimization algorithm such as stochastic gradient descent to update the model weights of its local ANN copy 110 in accordance with the decompressed (and inversely transformed) global gradient and current round can r end. Steps 602-622 can be subsequently repeated for additional rounds r+1, r+2, etc. until a termination criterion is reached that ends the DL/FL training procedure.

With the solution shown in FIG. 6, a number of advantages are realized. First this solution allows for efficient bi-directional gradient compression, such that both the gradients sent from the clients to the parameter server and the global gradient sent from the parameter server to the clients are communicated in compressed form. This results in greater network bandwidth savings over the uni-directional compression offered by existing solutions and thus improves training performance in bandwidth constrained scenarios. In some embodiments, the parameter server may re-quantize the compressed global gradient to further reduce its size prior to sending it back to the clients at step 616.

Second, as mentioned previously, this solution avoids the need for the parameter server to decompress and inversely transform (if applicable) the compressed gradients it receives from the clients in order to compute the global gradient; instead, the parameter server can simply aggregate the compressed gradients as-is and offload the decompression/inverse transform steps to each client. This is possible because the gradients are compressed by the clients using a common linear quantization technique per step 610, which means that there is no difference between (1) the parameter server decompressing each received gradient, aggregating the decompressed gradients to compute the global gradient, and providing the global gradient to the clients, and (2) the parameter server aggregating the compressed gradients to generate a compressed global gradient, providing the compressed global gradients to the clients, each of whom decompress and inversely transform the compressed global gradient to obtain the global gradient. Accordingly, the delays/overhead arising out of requiring the parameter server to perform these steps are eliminated, which is particularly significant if the inverse transform is super-linear in complexity.

The remainder of this disclosure describes various enhancements/optimizations that may be applied to the high-level solution of FIG. 6. It should be appreciated that FIGS. 1-6 are illustrative and not intended to limit embodiments of the present disclosure. For example, although parameter server 102 is depicted as a singular server/computer system, in some embodiments parameter server 102 may be implemented as a cluster of servers/computer systems for enhanced performance, reliability, and/or other reasons. One of ordinary skill in the art will recognize other variations, modifications, and alternatives.

### 4. Enhancements/Optimizations

### 4.1 Setting the Quantization Range

In embodiments where each participating client in a round r applies stochastic quantization with a common quantization range to compress its gradient, there are different ways in the common quantization range can be determined/set. For example, according to one approach, the quantization range can be fixed at the start of the training procedure and reused in each round. This tends to work well if a random rotation is applied to the gradient prior to quantization because the rotation operation homogenizes the distribution of gradient coordinates across clients, and thus a fixed quantization range can typically cover all gradients. For example, an administrator may statically set the quantization range based on empirical data and/or heuristics pertaining to the ANN to be trained or the training datasets. Alternatively, the training procedure may begin with an initial “warm-up” round in which each client computes its gradient and sends the range of lowest and highest gradient coordinates to the parameter server. The parameter server can then determine a fixed quantization range to be used for the remainder of the training procedure based on the received gradient coordinate information.

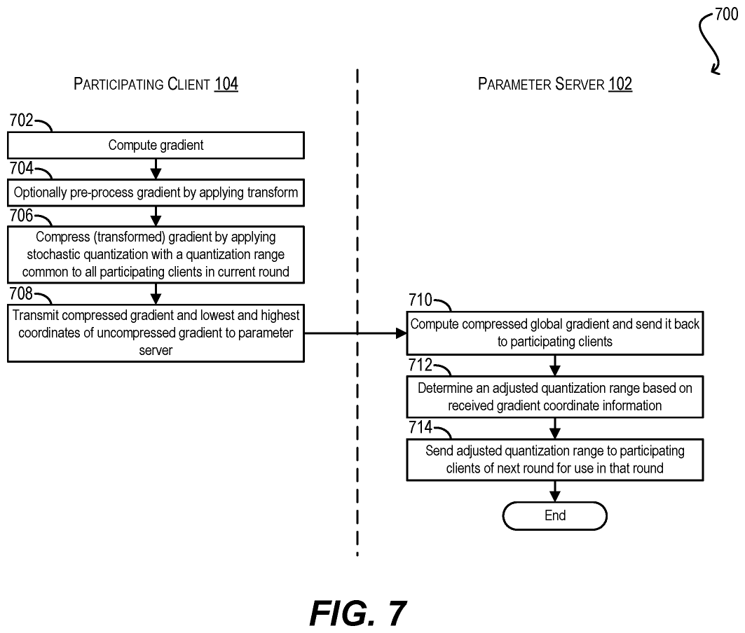

According to another approach that is illustrated via workflow 700 of FIG. 7, the quantization range can be dynamically adjusted on a per-round basis. Starting with steps 702-706, each participating client in a round r can compute its gradient, optionally pre-process the gradient using a transform, and compress the (transformed) gradient by applying stochastic quantization with a common quantization range set for r. Each participating client can then transmit both the compressed gradient and the lowest and highest coordinates of the original, uncompressed gradient to parameter server 102 (step 708).

Upon receiving this information, parameter server 102 can compute a compressed global gradient and send it back to the participating clients of r (step 708), who can in turn process the compressed global gradient in order to update the model weights of their respective local ANN copies per steps 618-622 of workflow 600 (not shown). In addition, parameter server 102 can determine an adjusted quantization range based on the received gradient coordinate information that better covers the clients' gradients (step 710). Finally, parameter server 102 can send the adjusted quantization range to all participating clients of next round r+1 for use in that next round (step 712).

### 4.2 Error Feedback for Out-of-Bounds Gradient Coordinates

As mentioned previously, when a client applies stochastic quantization to its gradient using a particular quantization range, it is possible for some gradient coordinates to fall below the range's lower bound or above the range's upper bound. Such coordinates may be automatically thresholded to the appropriate bound and the differences between the coordinates' real values and their thresholded values can be understood as errors introduced by the quantization process.

Rather than simply throwing away these errors, in certain embodiments the client can remember them and carry them forward to the next round via an error feedback mechanism. For example, assume the quantization range for round r is [−10, . . . , 10] and the first coordinate of the client's gradient is −11. In this case, the first coordinate will be thresholded to lower bound −10 in round r and the client can remember the difference between these two values (i.e., −1). Then, in next round r+1, the client can add the difference to the first coordinate of the gradient computed for r+1, thereby compensating for the error introduced by thresholding the first coordinate in prior round r.

Certain embodiments described herein can employ various computer-implemented operations involving data stored in computer systems. For example, these operations can require physical manipulation of physical quantities-usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
computing, by each client participating in a round of a distributed learning (DL) or federated learning (FL) procedure for training an artificial neural network (ANN), a gradient with respect to a local copy of the ANN;
compressing, by the client, the gradient using a linear quantization technique that is identical across all clients participating in the round;
transmitting, by the client, the compressed gradient to a parameter server;
receiving, by the client, a compressed global gradient from the parameter server;
decompressing, by the client, the compressed global gradient using the linear quantization technique; and
updating, by the client, one or more model weights of the local copy of the ANN based on the decompressed global gradient.

2. The method of claim 1 wherein upon receiving compressed gradients from said all clients participating in the round, the parameter server computes the compressed global gradient by aggregating the compressed gradients without performing any decompression.

3. The method of claim 1 wherein prior to compressing the gradient, the client pre-processes the gradient by applying a transform, and
wherein subsequently to decompressing the compressed global gradient, the client applies an inverse transform to the decompressed global gradient that corresponds to the transform.

4. The method of claim 3 wherein the transform and the inverse transform are super-linear in time complexity.

5. The method of claim 1 wherein the compressing comprises:
compressing the gradient using stochastic quantization with a quantization range that is common to said all clients participating in the round.

6. The method of claim 5 wherein the quantization range is statically set at the start of the DL or FL procedure.

7. The method of claim 5 wherein the quantization range is dynamically adjusted for each round of the DL or FL procedure.

8. A non-transitory computer readable storage medium having stored thereon program code executable by each client participating in a round of a distributed learning (DL) or federated learning (FL) procedure for training an artificial neural network (ANN), the program code causing the client to:
compute a gradient with respect to a local copy of the ANN;
compress the gradient using a linear quantization technique that is identical across all clients participating in the round;
transmit the compressed gradient to a parameter server;
receive a compressed global gradient from the parameter server;
decompress the compressed global gradient using the linear quantization technique; and
update one or more model weights of the local copy of the ANN based on the decompressed global gradient.

9. The non-transitory computer readable storage medium of claim 8 wherein upon receiving compressed gradients from said all clients participating in the round, the parameter server computes the compressed global gradient by aggregating the compressed gradients without performing any decompression.

10. The non-transitory computer readable storage medium of claim 8 wherein prior to compressing the gradient, the client pre-processes the gradient by applying a transform, and
wherein subsequently to decompressing the compressed global gradient, the client applies an inverse transform to the decompressed global gradient that corresponds to the transform.

11. The non-transitory computer readable storage medium of claim 10 wherein the transform and the inverse transform are super-linear in time complexity.

12. The non-transitory computer readable storage medium of claim 8 wherein the compressing comprises:
compressing the gradient using stochastic quantization with a quantization range that is common to said all clients participating in the round.

13. The non-transitory computer readable storage medium of claim 12 wherein the quantization range is statically set at the start of the DL or FL procedure.

14. The non-transitory computer readable storage medium of claim 12 wherein the quantization range is dynamically adjusted for each round of the DL or FL procedure.

15. A computer system participating in a round of a distributed learning (DL) or federated learning (FL) procedure for training an artificial neural network (ANN), the computer system comprising:
a processor; and
a non-transitory computer readable medium having stored thereon program code that, when executed by the processor, causes the processor to:
compute a gradient with respect to a local copy of the ANN;
compress the gradient using a linear quantization technique that is identical across all computer systems participating in the round;
transmit the compressed gradient to a parameter server;
receive a compressed global gradient from the parameter server;
decompress the compressed global gradient using the linear quantization technique; and
update one or more model weights of the local copy of the ANN based on the decompressed global gradient.

16. The computer system of claim 15 wherein upon receiving compressed gradients from said all computer systems participating in the round, the parameter server computes the compressed global gradient by aggregating the compressed gradients without performing any decompression.

17. The computer system of claim 15 wherein prior to compressing the gradient, the processor pre-processes the gradient by applying a transform, and
wherein subsequently to decompressing the compressed global gradient, the processor applies an inverse transform to the decompressed global gradient that corresponds to the transform.

18. The computer system of claim 17 wherein the transform and the inverse transform are super-linear in time complexity.

19. The computer system of claim 15 wherein the program code that causes the processor to compress the gradient comprises program code that causes the processor to:
apply stochastic quantization to the gradient with a quantization range that is common to said all computer systems participating in the round.

20. The computer system of claim 19 wherein the quantization range is statically set at the start of the DL or FL procedure.

21. The computer system of claim 19 wherein the quantization range is dynamically adjusted for each round of the DL or FL procedure.
